(19) United States
(12) Patent Application Publication
(10) Pub. No.: US 2024/0067561 A1
(43) Pub. Date: Feb. 29, 2024

(54) METHOD OF MANUFACTURING FLEXIBLE COVER WINDOW AND FLEXIBLE COVER WINDOW MANUFACTURED THEREBY

(71) Applicant: UTI INC., Chungcheongnam-do (KR)

(72) Inventors: Jae Suk OH, Chungcheongnam-do (KR); Seok Pil JIN, Chungcheongnam-do (KR); Kukhyun SUNWOO, Chungcheongnam-do (KR)

(73) Assignee: UTI INC., Chungcheongnam-do (KR)

(21) Appl. No.: 18/453,136

(22) Filed: Aug. 21, 2023

(30) Foreign Application Priority Data
Aug. 30, 2022 (KR) 10-2022-0109290

(51) Int. Cl. C03C 17/34; C03C 17/00

(52) U.S. Cl. CPC C03C 17/3405; C03C 17/001; C03C 2218/118; C03C 2218/32; C03C 2218/365

(57) ABSTRACT

Proposed is a method of manufacturing a flexible cover window containing a flat portion disposed on a flat area of a flexible display and a folding portion formed in connection to the flat portion and disposed on a folding area of the flexible display. The method is characterized by including: preparing a glass substrate; placing the glass substrate onto a carrier substrate; forming a first coating layer on the glass substrate containing the folding portion; forming a second coating layer on the first coating layer; and separating the glass substrate from the carrier substrate.

### CROSS REFERENCE TO RELATED APPLICATION

The present application claims priority to Korean Patent Application No. 10-2022-0109290, filed Aug. 30, 2022, the entire contents of which is incorporated herein for all purposes by this reference.

### BACKGROUND OF THE DISCLOSURE

### 1. Field of the Disclosure

The present disclosure relates to a method of manufacturing a flexible cover window having improved strength properties and folding properties by ensuring uniform thickness of a coating layer, and a flexible cover window manufactured thereby.

### 2. Description of the Related Art

Recently, electrical and electronic technologies are developing rapidly, and various types of display products are coming out to meet the needs of the new era and various consumers. Among these products, research on flexible displays that are foldable and stretchable is in progress.

Regarding flexible displays, research is being conducted on the foldable types, moving on to bendable, rollable, and stretchable types. In addition, not only display panels but also cover windows for protecting them need to be formed flexibly.

Such flexible cover windows are required to have high flexibility, no marks on a folding portion even when being repeatedly folded, and no distortion of image quality caused accordingly.

As for cover windows of currently available flexible displays, a polymer film, such as PI or PET film, has been used on the surface of the display panel.

However, such polymer films have poor mechanical strength, thereby serving only to prevent scratches from being left on a display panel, and have the following disadvantages: poor impact resistance, low transmittance, and relatively high price.

In addition, in the case of such polymer films, with the increasing number of times the display is folded, substantial marks remain on the folding portion, causing damage to the folding portion. For example, the polymer film is pressed or torn during folding limit evaluation (usually 200,000 times).

Recently, various studies on glass-based cover windows have been in progress to overcome the limitations of polymer film-based cover windows.

Such glass-based cover windows require basic physical properties that satisfy folding properties, have no screen distortion, and have sufficient strength against repeated contact with a touch pen under constant pressure.

The glass is required to have a predetermined or larger thickness to satisfy the strength properties of such cover windows but to have a predetermined or smaller thickness to satisfy the folding properties. Therefore, research on the thickness and structure of the optimal cover windows that satisfy both strength properties and folding properties while having no screen distortion is necessary.

In addition, when the thickness of the glass is equal to or smaller than a predetermined thickness, the original texture of tempered glass is poor, which needs to be taken into account.

Therefore, there is a growing need for technologies to provide cover windows that allow the aesthetics of tempered glass to be maintained while maintaining an appropriate thickness to ensure strength and satisfying folding properties.

There are some cases of forming a resin layer on one surface or both surfaces of the glass-based cover window to reinforce the strength properties and folding properties of the glass-based cover windows.

Typically, while thermosetting or photosetting resins are commonly used as the resin layer, shrinkage occurs during the curing process due to the nature of the resin, making it difficult to control the thickness of the resin layer.

In particular, when the folding portion of the cover window is formed to be slimmed down, the resin layer in the folding portion is further shrunken, making it more difficult to control the thickness of the cover window. In addition, there is a concern that the strength properties and folding properties may be deteriorated.

Furthermore, the overall thickness uniformity of the cover window is poor, which affects the resolution and deteriorates the durability when attached to the display.

### SUMMARY OF THE INVENTION

The present disclosure has been proposed to solve the problems described above, and an objective of the present disclosure is to provide a method of manufacturing a flexible cover window having improved strength properties and folding properties by forming a coating layer on a glass substrate through a coating process performed two or more times and thus enabling the coating layer to have a uniform thickness, and a flexible cover window manufactured thereby.

To accomplish the objective of the present disclosure, the present disclosure relates to a method of manufacturing a flexible cover window containing a flat portion disposed on a flat area of a flexible display and a folding portion formed in connection to the flat portion and disposed on a folding area of the flexible display, and a flexible cover display manufactured thereby. The method includes: preparing a glass substrate; placing the glass substrate onto a carrier substrate; forming a first coating layer on the glass substrate containing the folding portion; forming a second coating layer on the first coating layer; and separating the glass substrate from the carrier substrate.

In addition, the carrier substrate preferably includes a first film in which a first adhesive layer is formed on one surface and a second film bonded onto the first adhesive layer of the first film. A substrate receiving portion composed of the second film and the first adhesive layer is preferably formed by cutting a portion of the second film and separating the cut portion of the second film from the first adhesive layer. The glass substrate is preferably received in the substrate receiving portion and bonded to the first adhesive layer.

In addition, a second adhesive layer is preferably formed on one surface of the second film such that the second adhesive layer and the first adhesive layer of the first film are bonded while facing each other. The substrate receiving portion is preferably formed by cutting the carrier substrate down to the second adhesive layer.

In addition, preferably, the substrate receiving portion has a depth equal to a thickness of the flat portion of the glass substrate or a depth smaller than the thickness of the flat portion of the glass substrate by up to 20%. A distance between the side surface of the substrate receiving portion and the side surface of the glass substrate is preferably in a range of 1 to 2 mm.

In addition, the substrate receiving portion is preferably formed by cutting the second film with a laser beam.

In addition, the first and second coating layers are preferably formed by performing a bar coating process or a roll coating process.

In addition, the second coating layer is preferably formed after the first coating layer is completely cured.

In addition, preferably, in the forming of the first coating layer and the forming of the second coating layer, the first coating layer is formed by applying a first coating solution onto an outer area of the glass substrate and then performing the bar coating process or the roll coating process, and the second coating layer is formed on the first coating layer by applying a second coating solution onto the outer area of the glass substrate and then performing the bar coating process or the roll coating process.

In addition, the bar coating process and the roll coating process preferably allow each of the first and second coating layers to be sequentially formed by: applying the coating solution and moving a bar toward the glass substrate; applying the coating solution, forming the coating layer by moving the bar toward the glass substrate, covering an upper portion of the coating layer with a release glass, rolling a roll, and then removing the release glass; or applying the coating solution, supplying the release glass to cover the upper portion of the glass substrate with the release glass so that the coating solution is evenly applied on the glass substrate, rolling the roll on the top of the release glass, and then removing the release glass.

In addition, during the bar coating process or the roll coating process, the first coating solution is preferably provided between the side surface of the substrate receiving portion and the side surface of the glass substrate so that the first coating layer is further formed on the side surface of the glass substrate.

In addition, after the second coating layer is formed, a first protective film is preferably laminated on an upper portion of the second coating layer.

In addition, in the separating of the glass substrate from the carrier substrate, the glass substrate is preferably separated from the first adhesive layer after vertically cutting the first protective film, the second coating layer, and the first coating layer.

In addition, preferably, after the first protective film is laminated, the first film is removed, and the bar coating process or the roll coating process is performed to form a third coating layer or the third coating layer and a fourth coating layer on the back surface of the glass substrate, thereby forming the coating layer on both surfaces of the glass substrate.

In addition, a second protective film is preferably laminated on an upper portion of the third coating layer or an upper portion of the third and fourth coating layers.

In addition, the separating of the glass substrate from the carrier substrate may be implemented by vertically cutting the second protective film, the third coating layer, the second coating layer, the first coating layer, and the first protective film, or by vertically cutting the second protective film, the fourth coating layer, the third coating layer, the second coating layer, the first coating layer, and the first protective film.

In this case, the folding portion may be formed on both surfaces of the glass substrate.

In addition, preferably, after placing the glass substrate onto the carrier substrate, a coating surface of the glass substrate is subjected to plasma treatment and then cleaned.

In addition, the first coating layer is preferably further formed on the side surface of the glass substrate.

In addition, preferably, the first, second, third, and fourth coating layers formed on the flat portion have a thickness in a range of 8 to 12 μm, and the coating layers have a thickness uniformity of 0.2 μm or less.

The present disclosure provides a flexible cover window having improved strength properties and folding properties by forming a coating layer on one surface or both surfaces of a glass substrate.

In the present disclosure, the coating layer is formed on the glass substrate in a multilayer structure through a coating process performed two or more times, thereby ensuring thickness uniformity and flatness. In Particular, in the case of the glass substrate containing a folding portion having a smaller thickness than a flat portion, the difference between the shrinkage rates of resins in the folding portion and the flat portion can be reduced. As a result, the thickness uniformity and the flatness of the coating layer can be improved while facilitating thickness control, thereby improving the strength properties and folding properties of the flexible cover window.

### BRIEF DESCRIPTION OF THE DRAWINGS

FIGS. 1A, 1B, 1C, 1D, 1E, 1F, 1G, 1H, and 1I illustrate schematic views of a method of manufacturing a flexible cover window according to one embodiment of the present disclosure;

FIG. 2 illustrates a schematic plan view according to the embodiment of FIG. 1C;

FIGS. 3 and 4 illustrate schematic views of a coating process according to one embodiment of the present disclosure;

FIGS. 5A, 5B, 5C, 5D, 5E, 5F, 5G, 5H, 5I, 5J, 5K, 5L, 5M, 5N, 5O, and 5P illustrate schematic views of a method of manufacturing a flexible cover window according to another embodiment of the present disclosure;

FIGS. 6 and 7 illustrate schematic views of flexible cover windows according to various embodiments of the present disclosure;

FIGS. 8A and 8B show cross-sectional images of flexible cover windows according to one embodiment of the present disclosure;

FIG. 9 illustrates a schematic plan view of a cover window in which a folding portion (B-zone) is formed to have a smaller thickness than a flat portion (110, A-zone and C-zone) (numbers are marked at each point where the thickness is measured to measure the overall thickness distribution);

FIG. 10 is a view showing thickness distribution measurement data in the case of forming a single coating layer on a glass substrate containing an existing folding portion (Comparative Examples); and

FIG. 11 is a view showing thickness distribution measurement data in the case of forming two coating layers on a glass substrate containing a folding portion according to one embodiment of the present disclosure.

### DESCRIPTION OF THE PREFERRED EMBODIMENTS

The present disclosure aims to improve strength properties and folding properties of a glass-based cover window by forming a coating layer on one surface or both surfaces of a glass substrate.

In particular, when the coating layer is formed on the glass substrate in which a folding portion is formed to have a smaller thickness than a flat portion, the present disclosure aims to complement the strength properties and folding properties deteriorated by a decrease in the flatness of the coating layer, difficulty in thickness control, a difference between shrinkage rates in the folding portion and the flat portion, and the like occurring during a coating process and a curing process. The coating layer is formed in a multilayer structure through a multi-coating process performed two or more times, thereby enabling the thickness control and uniformity of the coating layer to be ensured and improving the strength properties and folding properties.

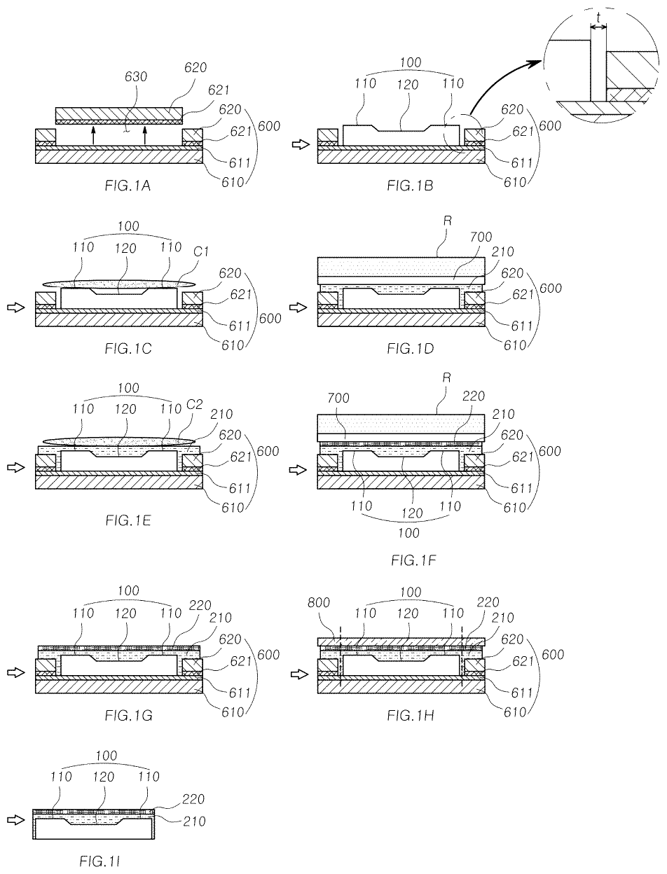

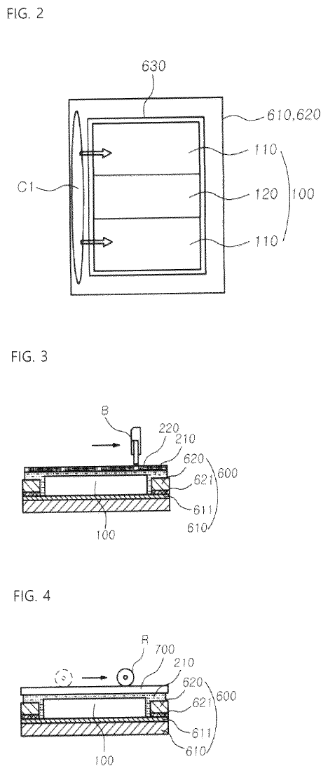

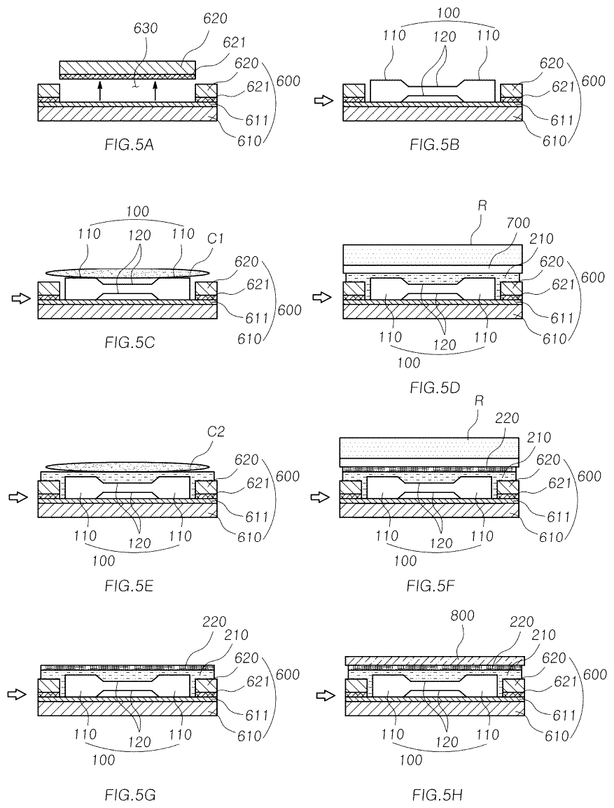

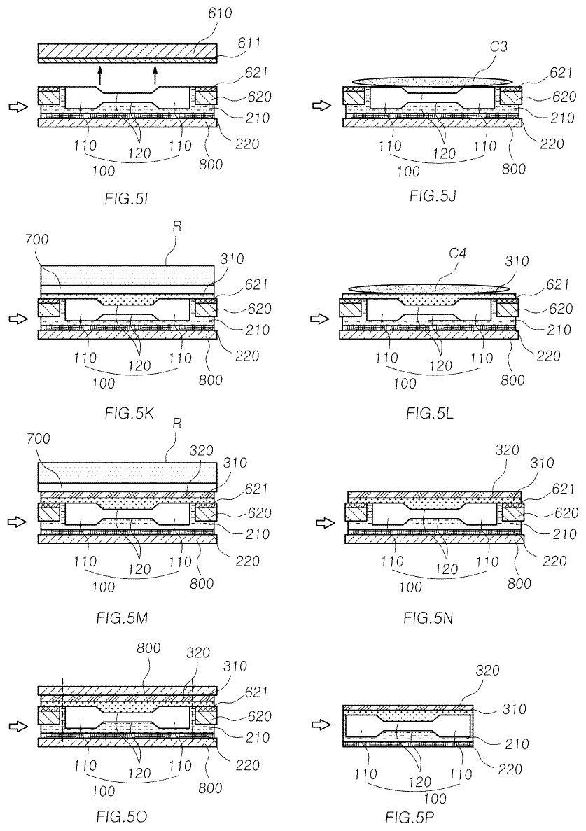

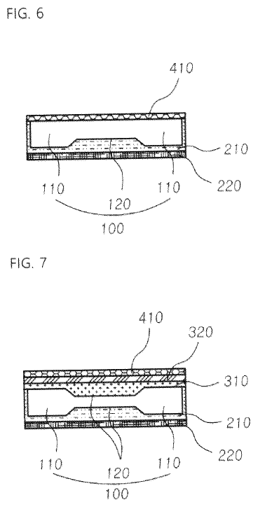

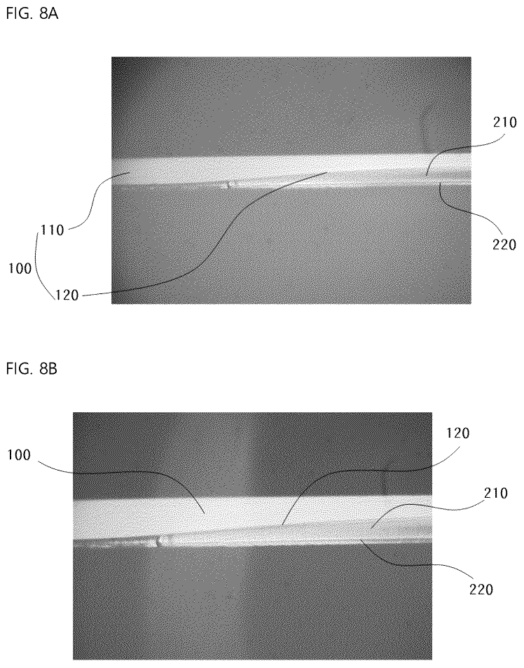

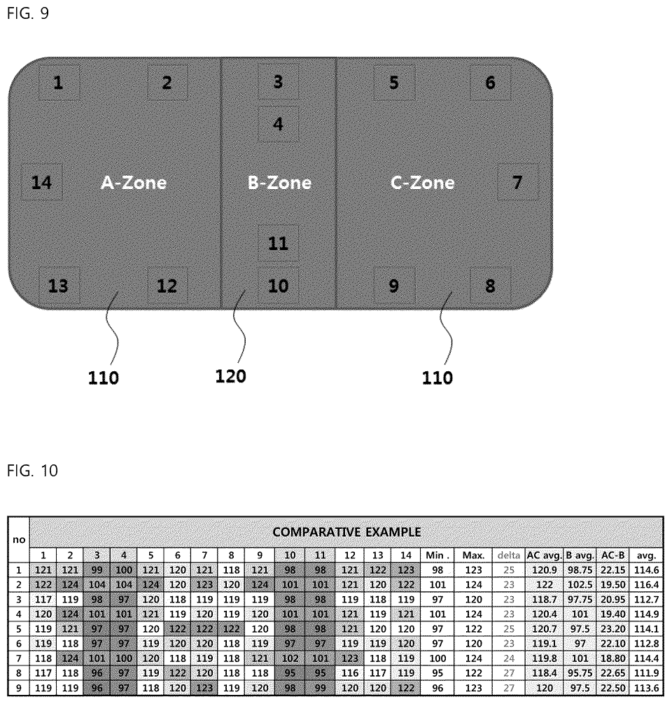

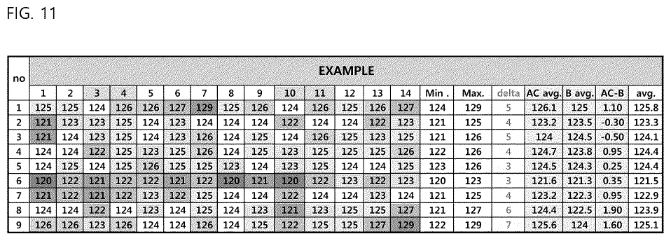

Hereinafter, embodiments of the present disclosure will be described in detail with reference to the accompanying drawings. FIGS. 1A, 1B, 1C, 1D, 1E, 1F, 1G, 1H, and 1I illustrate schematic views of a method of manufacturing a flexible cover window according to one embodiment of the present disclosure. FIG. 2 illustrates a schematic plan view according to the embodiment of FIG. 1C. FIGS. 3 and 4 illustrate schematic views of a coating process according to one embodiment of the present disclosure. FIGS. 5A, 5B, 5C, 5D, 5E, 5F, 5G, 5H, 5I, 5J, 5K, 5L, 5M, 5N, 5O and 5P illustrate schematic views of a method of manufacturing a flexible cover window according to another embodiment of the present disclosure. FIGS. 6 and 7 illustrate schematic views of flexible cover windows according to various embodiments of the present disclosure. FIGS. 8A and 8B show cross-sectional images of flexible cover windows according to one embodiment of the present disclosure. FIG. 9 illustrates a schematic plan view of a cover window in which a folding portion (B-zone) is formed to have a smaller thickness than a flat portion 110 (A-zone and C-zone) (numbers are marked at each point where the thickness is measured to measure the overall thickness distribution). FIG. 10 is a view showing thickness distribution measurement data in the case of forming a single coating layer on a glass substrate containing an existing folding portion (Comparative Examples). FIG. 11 is a view showing thickness distribution measurement data in the case of forming two coating layers on a glass substrate containing a folding portion according to one embodiment of the present disclosure.

As illustrated, a method of manufacturing a flexible cover window according to the present disclosure, the cover window containing a flat portion 110 disposed in a flat area of a flexible display and a folding portion 120 formed in connection to the flat portion 110 and disposed in a folding area of the flexible display, includes: preparing a glass substrate 100 in which the folding portion 120 is formed to have a smaller thickness than the flat portion 110; placing the glass substrate 100 onto a carrier substrate such that the folding portion 120 faces upward; forming a first coating layer 210 on the glass substrate 100 containing the folding portion 120; forming a second coating layer 220 on the first coating layer 210; and separating the glass substrate 100 from the carrier substrate 600.

In the present disclosure, the folding area of the display means a folded portion, a rolled portion, a pushed/pulled portion, and a stretched portion in the case of folding, bending, rolling, sliding, or stretching the display. In the present disclosure, a portion corresponding to the above area is called the “folding portion” of the cover window, and the flat area other than the folding portion is called the “flat portion” of the cover window.

The present disclosure is based on glass and may be applied to a case where a partial area of the glass substrate 100, that is, the folding portion 120, is formed to have a smaller thickness than the flat portion 110. However, the present disclosure is not limited thereto, and may be applied to the case where the flat portion 110 and the folding portion 120 have uniform thickness. In addition, the present disclosure may be applied to the case where the folding portion 120, having a smaller thickness than the flat portion 110, is formed on both surfaces.

As for the glass substrate 100 according to the present disclosure, a chemically toughened glass substrate 100 may be used. When the folding portion 120 is formed to have a smaller thickness than the flat portion 110, the flat portion 110 may have a thickness in a range of 50 to 300 μm, and the folding portion 120 may have a thickness in a range of about 10 to 150 μm, meaning that a thin film-form glass having an excessively small thickness is processed to form the folding portion 120.

The present disclosure aims to improve the strength properties and folding properties by forming the coating layer containing a resin on one surface or both surfaces of the glass substrate 100. The coating layer of the present disclosure, used to solve difficulties in thickness control caused by lack of thickness uniformity, a decrease in flatness, and shrinkage, is formed through the multi-coating process involving the coating process performed at least two or more times.

FIGS. 1A, 1B, 1C, 1D, 1E, 1F, 1G, 1H, and 1I illustrate a method of forming the coating layer on the glass substrate 100 in which the folding portion 120 is formed to have a smaller thickness than the flat portion 110, according to one embodiment of the present disclosure. In one embodiment of the present disclosure, when the folding portion 120 is formed on one surface, the flat portion 110 has a thickness of 100 μm, and the folding portion 120 has a thickness of 60 μm.

First, the glass substrate 100 is placed onto the carrier substrate 600 such that the folding portion 120 faces upward (FIGS. 1A and 1B). As for the carrier substrate 600, a material having a certain degree of strength may be used to stably support the glass substrate 100. For example, polyethylene terephthalate (PET), polypropylene (PP), polyethylene naphthalate (PEN), and polycarbonate (PC) may be used, including but not limited thereto.

An adhesive layer is formed on the carrier substrate 600 to fix the glass substrate 100 and facilitate the separation of the glass substrate 100 from the carrier substrate 600.

Specifically, the carrier substrate 600 contains a first film 610 on which a first adhesive layer 611 is formed on one surface, and a second adhesive layer 620 bonded onto the first adhesive layer 611 of the first film 610. That is, the carrier substrate 600, according to one embodiment of the present disclosure, is formed by bonding two films made of the same or different materials. A second adhesive layer 621 may also be formed on one surface of the second film 620. In this case, in the carrier substrate 600, the first adhesive layer 611 and the second adhesive layer 621 are bonded while facing each other.

In one embodiment of the present disclosure, while the first film 610 and the second film 620 are bonded, a portion of the second film 620 is cut. The cut portion of the second film 620 is separated (removed) from the first adhesive layer 611 to form a substrate receiving portion 630 composed of the second film 620 and the first adhesive layer 611 (FIG. 1A). The glass substrate 100 is received in the substrate receiving portion 630 and bonded to the first adhesive layer 611 (FIG. 1B).

In addition, the second adhesive layer 621 may be formed on one surface of the second film 620, and thus is bonded onto and faces the first adhesive layer 611 of the first film 610, so the substrate receiving portion 630 may be formed by cutting the carrier substrate 600 down to the second adhesive layer 621.

The substrate receiving portion 630 is formed at a predetermined depth from the surface of the carrier substrate 600 by cutting or etching the carrier substrate 600. In one embodiment of the present disclosure, the substrate receiving portion 630 is formed by bonding the second film 620 onto the first film 610, and then cutting a portion of the second film 620 to separate the cut portion of the second film 620 from the first film 610. In this case, the second film 620 is cut with a laser beam so that the substrate receiving portion 630 is accurately and precisely formed.

The substrate receiving portion 630 in which the glass 100 is received serves to fix the glass substrate 100 so that it does not move during the coating process and to assist the coating process to be facilitated.

The substrate receiving portion 630 is formed at a depth that is equal to or smaller than the thickness of the flat portion 110 of the glass substrate 100 to improve coatability in the coating process, that is, to uniformly apply a coating solution on the entire area of the glass substrate 100 and ensure the thickness uniformity of the coating layer.

Specifically, the substrate receiving portion 630 preferably has a depth smaller than the thickness of the flat portion 110 of the glass substrate 100 by up to 20%. In other words, when the flat portion 110 of the glass substrate 100 has a thickness of 100 μm, the substrate receiving portion 630 may have a depth in a range of about 80 to 100 μm.

When the depth of the substrate receiving portion 630 is formed to be smaller than the above range, the thickness flatness or uniformity of the coating layer may be poor. In addition, there is a concern that a roll R or bar B may get stuck on the glass substrate 100 during the coating process. Furthermore, even when the coating layer is formed, the coating layer may have an excessively small thickness, or the coating layer may partially fail to be formed.

On the contrary, when the depth of the substrate receiving portion 630 is formed to be larger than thickness of the glass substrate 100, the thickness of the entire area of the glass substrate 100 and the folding portion 120 may be lack of the thickness uniformity, and the flatness may also be poor, as described above.

In this case, the substrate receiving portion 630 is preferably formed to have a larger width than that of the glass substrate 100, that is, such that a distance exists between the side surface of the substrate receiving portion 630 and the side surface of the glass substrate 100.

The existence of the distance t enables the coating layer to be formed not only on one surface (the front or back surface) or both surfaces (the front and back surfaces) of the glass substrate 100 but also on the side surface, at the same time. In addition, the existence of the distance t facilitates the coating solution to flow smoothly and thus contributes to the coatability. Furthermore, when separating the completed cover window from the carrier substrate 600 to be described later, the distance t serves as a space where laser cutting lines are formed.

Specifically, the distance t between the side surface of the substrate receiving portion 630 and the side surface of the glass substrate 100 is formed to be in a range of about 1 to 2 mm. As a result, the substrate receiving portion 630 is kept from having an excessively larger width than that of the glass substrate 100 while keeping the coatability of the front, back, and side surfaces at moderate levels.

When the distance t is smaller than the above range, the coating solution may fail to flow smoothly, thereby deteriorating the coating uniformity. In addition, the coating may be poorly performed on the side surface. On the contrary, when the distance t is larger than the above range, the coating solution may be wasted, and the coating may be poorly performed on the side surface. Furthermore, the movement of the bar B and the roll R may be disturbed during a bar coating process and a roll coating process.

After placing the glass substrate 100 onto the substrate receiving portion 630 of the carrier substrate 600, the first coating layer 210 is formed on the glass substrate 100 containing the folding portion 120 (FIGS. 1C, 2, and 1D), and then the second coating layer 220 is formed on the first coating layer 210 (FIGS. 1E, 1F, and 1G).

The present disclosure aims to form the coating layer on the glass substrate 100 while performing the multi-coating process two or more times to improve thickness uniformity and flatness, and aims to facilitate thickness control, as described above. That is, when forming the coating layer with a uniform thickness, the coating process is performed multiple times rather than one time to improve the thickness uniformity and the flatness of the coating layer.

In particular, when performing the coating process one time on the glass substrate 100 in which the folding portion 120 is formed to have a smaller thickness than the flat portion 110 according to one embodiment of the present disclosure, the resins in the folding portion 120 and the flat portion 110 may significantly differ in shrinkage rate. As a result, the thickness uniformity and the flatness of the coating layer are deteriorated, which in turn led to deterioration not only in the durability but also in the folding properties and strength properties of the cover window.

Therefore, in the present disclosure, the first coating layer 210 is formed over the entire area of the glass substrate 100 containing the folding portion 120, and the second coating layer is formed over the entire area of the upper portion of the first coating layer 210 in accordance with the thickness of the designed coating layer. Accordingly, the difference between shrinkage rates of resins in the folding portion 120 and the flat portion 110 may be reduced, thereby improving the thickness uniformity and the flatness of the coating layers. The coating layers may be formed in a multilayer structure by further performing the coating process multiple times, as needed.

The first coating layer 210 and the second coating layer 220, according to the present disclosure, may be formed by the bar coating process or the roll coating process.

The bar coating process and the roll coating process, according to the present disclosure, are excellent in surface uniformity of the coating layer, compared to existing spraying processes and the like, and further improve the thickness uniformity, thereby being suitably applied when forming the uniform coating layers over the entire area of the thin film-form glass substrate 100.

When performing such a bar coating process and a roll coating process, the second coating layer 220 is formed after the first coating layer 210 is completely cured, thereby minimizing the shrinkage rates between the resins in the flat portion 110 and the folding portion 120.

Hereinafter, the bar coating process and the roll coating process will be described in more detail.

As illustrated in FIGS. 2 to 4, in the bar coating process and the roll coating process, a first coating solution C1 is applied onto an outer area of the glass substrate 100 to form the first coating layer 210 using the bar B or the roll R. Then, a second coating solution C2 is applied onto the outer area of the glass substrate 100 to form the second coating layer 220 using the bar B or the roll R.

FIG. 2 is a schematic plan view (scale is slightly adjusted) according to the embodiment of FIG. 1C, provided for explaining the application position of the coating solution and the movement direction of the bar or roll of the present disclosure. As illustrated, the coating solution is applied onto the outer area of the glass substrate 100 at one side of the folding portion 120, and the bar or the roll is moved in the direction of an arrow (parallel to the folding direction). As a result, the area of the folding portion 120 is allowed to be filled with the coating solution while the coating layers are formed uniformly over the entire area of the glass substrate 100.

Specifically, the bar coating process or the roll coating process allows each of the first coating layer 210 and the second coating layer 220 to be sequentially formed by: 1) applying the coating solution onto a specific area to perform bar coating or roll coating on the glass substrate 100, and moving the bar B toward the glass substrate 100; 2) applying the coating solution, forming a primary coating layer by moving the bar toward the glass substrate 100, covering the top of the primary coating layer with a release glass 700, and then rolling the roll to remove the release glass 700; or 3) applying the coating solution, supplying the release glass 700 to cover the upper portion of the glass substrate 100 with the release glass 700 so that the coating solution is evenly applied on the glass substrate 100, rolling the roll on the top of the release glass, and then removing the release glass 700.

As illustrated in FIGS. 2 and 3, in the bar coating process according to one embodiment of the present disclosure, the first coating solution C1 is first applied onto the outer area of the glass substrate 100. The first coating solution C1 is quantitatively supplied from a dispenser in consideration of the thickness of the first coating layer 210. In particular, the first coating solution C1 is applied onto the outer area of the glass substrate 100 rather than the area of the glass substrate 100. In one embodiment of the present disclosure, the first coating solution C1 may be applied onto the second film 620 at one side of the folding portion 120, which encompasses the substrate receiving portion 630 formed around the perimeter of the glass substrate 100.

When the coating solution is applied onto the glass substrate 100, traces of droplets remain on the glass substrate 100, thus deteriorating visibility. Therefore, the coating solution is applied onto the outer area rather than the inner area of the glass substrate 100. Then, the first coating layer 210 may be uniformly formed on the glass substrate 100 containing the folding portion 120 by moving the bar B in parallel to the folding direction of the glass substrate 100.

In addition, the first coating layer 210 may be formed by applying the first coating solution C1, forming the primary coating layer by moving the bar B toward the glass substrate 100, covering the top of the primary coating layer with the release glass 700, rolling the roll R, and then removing the release glass 700. That is, the uniformity and flatness of the coating layer may be further improved by additionally performing roll coating after the bar coating process.

The first coating layer 210 is formed and then completely cured (heat curing or light curing). Next, the second coating layer 220 is formed on the first coating layer 210 by performing the bar coating process or the bar coating process and the roll coating process in the same manner as described above.

According to one embodiment of the present disclosure, the first coating layer 210 and the second coating layer 220 are formed on the flat portion 110 to have a thickness in a range of 8 to 12 μm. When the thickness is larger than the above range, the thickness of the cover window itself may become large, thereby deteriorating the folding properties. On the contrary, when the thickness is smaller than the above range, the ability to dissipate the impact force may be minimal, thereby hardly affecting the strength properties.

As illustrated in FIGS. 2 and 4, in the case of performing the roll coating process according to one embodiment of the present disclosure, the first coating layer 210 and the second coating layer 220 are sequentially formed by applying the coating solution onto the outer area of the glass substrate 100, supplying the release glass 700 to the position where the coating solution was applied so that the coating solution is evenly applied on the glass substrate 100 by allowing the release glass 700 to naturally and closely covering the upper portion of the glass substrate 100, and rolling the roll R on the top of the release glass 700. Before or after removing the release glass 700, the coating layer is completely cured through heat curing or light (ultraviolet) curing. The release glass 700, which has a thickness of about 1 mm, naturally falls on the glass substrate 100 (the coating layer) along the folding direction at the position where the coating liquid is applied while being closely covered.

After the first coating layer 210 is formed and completely cured (by heat or light), the second coating layer 220 is formed on the first coating layer 210 by performing the roll coating process in the same manner as described above. According to one embodiment of the present disclosure, the first coating layer 210 and the second coating layer 220 formed on the flat portion 110 have a thickness in a range of 8 to 12 μm. When the thickness is larger than the above range, the thickness of the cover window itself may become large, thereby deteriorating the folding properties. On the contrary, when the thickness is smaller than the above range, the ability to dissipate the impact force may be minimal, thereby hardly affecting the strength properties.

In addition, the distance t exists between the side surface of the substrate receiving portion 630 and the side surface of the glass substrate 100, as described above. Thus, the coating layer may be formed not only on one surface (the front or back surface) or both surfaces (the front and back surfaces) of the glass substrate 100 but also on the side surface thereof, at the same time.

That is, the substrate receiving portion 630 allows the first coating solution C1 to penetrate between the side surface of the substrate receiving portion 630 and the side surface of the glass substrate 100 (the distance t), thereby forming the first coating layer 210 on the side surface of the glass substrate 100.

In this case, before forming the coating layer (the first coating layer 210), the coating surface of the glass substrate 100 is subjected to plasma treatment to improve the coatability of the coating solution and remove impurities. Then, the coating process is performed after undergoing ultrasonic cleaning. In one embodiment of the present disclosure, the plasma treatment is performed under an argon and oxygen gas atmosphere by setting a contact angle on the surface to less than 20 degrees to improve the wettability of the coating solution.

As described above, the method of forming the first coating layer 210 and the second coating layer 220 on the glass substrate 100, according to the present disclosure, involves: placing the glass substrate 100 onto the carrier substrate inside which the substrate receiving portion 630 is formed, applying the first coating solution C1, undergoing the curing process by performing a primary bar coating or roll coating (supplying the release glass 700), applying the second coating solution C2, and undergoing the curing process by performing a secondary bar coating or roll coating (supplying the release glass 700).

When the formation of the second coating layer 220 is completed, the release glass 700 is removed, and the first protective film 800 is laminated on an upper portion of the second coating layer 220 (FIGS. 1G and 1H).

Next, the first protective film 800, the second coating layer 220, and the first coating layer 210 (including the first coating layer formed on the side) are vertically cut (FIG. 1H). Then, the separation of glass substrate 100 from the first adhesive layer 611 enables the glass substrate 100 to be separated from the carrier substrate 600.

In this case, the cutting is performed with a laser beam, and the first protective film 800 is detached after separating the glass substrate 100 from the carrier substrate 600. As a result, provided is the cover window in which the first coating layer 210 and the second coating layer 220 are formed on the glass substrate 100 in which the folding portion 120 is formed (FIG. 1I). The first protective film 800 may be provided in a laminated form, as needed.

As for the first protective film 800, polyethylene terephthalate (PET), polypropylene (PP), polyethylene naphthalate (PEN), and polycarbonate (PC) may be used.

FIG. 6 illustrates the cover window manufactured according to one embodiment of the present disclosure. Typically, the surface on which the folding portion 120 is formed is in contact with a display surface, and the opposite surface becomes a touch surface. FIG. 6 illustrates a case where a hard coating layer 410 is additionally formed on the touch surface (the upper surface in the drawing). The hard coating layer 410 may be formed by performing the bar coating process or the roll coating process, according to the present disclosure, and may also be formed by typical coating processes.

On the other hand, the first coating layer 210, the second coating layer 220, and the hard coating layer 410 of the present disclosure are formed of a transparent resin, such as an optical clear resin (OCR) matched with the refractive index of glass (1.5). For example, acryl, epoxy, silicone, urethane, urethane compounds, urethane acrylic compounds, hybrid sol-gels, siloxane-based resins, and the like may be used. The transparent resins may be mixed in various combinations depending on the nature thereof and used for reinforcing strength and elasticity.

For example, the content of resins, such as acrylic or epoxy, is increased to enhance the strength, and the contents of silicone, urethane synthetic resins, and the like are increased to reduce the strength. In addition, the contents of organic and inorganic substances in an organic-inorganic hybrid sol-gel may be adjusted and used to reinforce strength or elasticity.

In another embodiment of the present disclosure, when the folding portion 120, formed to have a smaller thickness than the flat portion 110, is formed on both surfaces of the glass substrate 100, all the processes, including the process of laminating the first protective film, are performed, as in the embodiment of FIGS. 1A, 1B, 1C, 1D, 1E, 1F, 1G, 1H, and 1I (FIGS. 5A to 5H). After turning over the carrier substrate 600, the first film 610 is removed (FIG. 5I). The first adhesive layer 611 allows the first film 610 and the glass substrate 100 to be bonded, so the first film 610 can be easily separated from the glass substrate 100.

Then, a third coating solution C3, or the third coating liquid C3 and a fourth coating solution C4 may be applied onto the other surface (the front or back surface) of the glass substrate 100 to form a third coating layer 310, or the third coating layer 310 and a fourth coating layer, respectively, by performing the bar coating process or the roll coating process (FIGS. 5J to 5N).

Thereafter, a second protective film 800 is laminated on an upper portion of the third coating layer 310 or an upper portion of the fourth coating layer 320 (FIG. 5O). Then, the glass substrate 100 is separated from the carrier substrate 600 (the second film in this case) by cutting the second protective film 800, the third coating layer 310, the second coating layer 220, the first coating layer 210 (including the first coating layer formed on the side), and the first protective film 800, or by cutting the second protective film 800, the fourth coating layer 320, the third coating layer 310, the second coating layer 220, the first coating layer 210, and the first protective film 800. Next, the remaining first and second protective films 800 are detached to provide the cover window (FIG. 5P). In the cover window, the first coating layer 210, the second coating layer 220, and the third coating layer 310, or the first coating layer 210, the second coating layer 220, the third coating layer 310, and the fourth coating layer 320 are formed on the glass substrate in which the folding portions 120 are formed on both surfaces. The first protective film 800 and the second protective film 800 may be provided in laminated forms, as needed.

As for the second protective film 800, polyethylene terephthalate (PET), polypropylene (PP), polyethylene naphthalate (PEN), or polycarbonate (PC) may be used, as in the first protective film 800.

FIG. 7 illustrates the double-sided slimmed-down folding portion 120, formed according to the embodiment of the present disclosure, and the cover window in which the coating layers are formed on both surfaces. In this case, the hard coating layer 410 is additionally formed on the touch surface (the upper surface in the drawing). The hard coating layer 410 may be formed by performing the bar coating process or the roll coating process according to the present disclosure, or by performing known coating processes.

FIGS. 8A and 8B show cross-sectional images of flexible cover windows according to one embodiment of the present disclosure, in which FIG. 8A is enlarged 280 times, and FIG. 8B is enlarged 420 times. It was confirmed that the first coating layer 210 and the second coating layer 220 were formed on the glass substrate 100 in which the folding portion was formed.

According to the embodiment of the present disclosure, the interface of the first coating layer 210 and the second coating layer 220 was not visually identified, and the visibility of the display image at the interface of the first coating layer 210 and the second coating layer 220 was not affected either.

FIG. 9 illustrates a schematic plan view of the cover window in which the folding portion (B-zone) is formed to have a smaller thickness than the flat portion 110 (A-zone and C-zone). In this case, numbers were marked at each point where the thickness was measured to measure the overall thickness distribution.

FIGS. 10 and 11 show data obtained by forming the coating layer on the glass substrate containing the folding portion and then measuring the thickness at each point marked as numbers. FIG. 10 shows thickness distribution measurement data in the case of forming a single coating layer on a glass substrate containing an existing folding portion (Comparative Examples), and FIG. 11 shows thickness distribution measurement data in the case of forming two coating layers on the glass substrate containing the folding portion according to one embodiment of the present disclosure.

In Comparative Examples (FIG. 10), the difference (delta) between the maximum thickness value (Max.) and the minimum thickness value (Min.) was in the range of 23 to 27 μm. In Examples of the present disclosure (FIG. 11), the difference (delta) between the maximum thickness value (Max.) and the minimum thickness value (Min.) was observed to be in the range of 3 to 7 μm.

Compared to FIG. 10, it was confirmed that the thickness distribution measurement data of FIG. 11 showed much more uniform values. In addition, it was confirmed that the thickness shrinkage rates (AC-B value) at the folding portion (positions 3, 4, 10, and 11) were significantly reduced in Examples of the present disclosure.

As a result, the present disclosure enabled the thickness of the coating layer to be obtained closely to the design value through the quantitatively applied coating solutions. In addition, it was confirmed that the thickness uniformity and flatness in the entire area of the glass substrate were excellent.

As described above, in the present disclosure, the coating layers are formed on the glass substrate in the multilayer structure through the coating process performed two or more times, thereby ensuring thickness uniformity and flatness. In Particular, in the case of the glass substrate containing the folding portion having a smaller thickness than the flat portion, the difference between the shrinkage rates of the resins in the folding portion and the flat portion can be reduced. As a result, the thickness uniformity and the flatness of the coating layer can be improved while facilitating thickness control, thereby improving the strength properties and folding properties of the flexible cover window.

What is claimed is:

1. A method of manufacturing a flexible cover window containing a flat portion disposed on a flat area of a flexible display and a folding portion formed in connection to the flat portion and disposed on a folding area of the flexible display, the method comprising:
preparing a glass substrate;
placing the glass substrate onto a carrier substrate;
forming a first coating layer on the glass substrate containing the folding portion;
forming a second coating layer on the first coating layer; and
separating the glass substrate from the carrier substrate.

2. The method of claim 1, wherein the carrier substrate comprises a first film in which a first adhesive layer is formed on one surface and a second film bonded onto the first adhesive layer of the first film,
wherein a substrate receiving portion composed of the second film and the first adhesive layer is formed by cutting a portion of the second film and separating the cut portion of the second film from the first adhesive layer, and
the glass substrate is received in the substrate receiving portion and bonded to the first adhesive layer.

3. The method of claim 2, wherein a second adhesive layer is formed on one surface of the second film such that the second adhesive layer and the first adhesive layer of the first film are bonded while facing each other, and
the substrate receiving portion is formed by cutting the carrier substrate down to the second adhesive layer.

4. The method of claim 2, wherein the substrate receiving portion has a depth equal to a thickness of the flat portion of the glass substrate, or
the substrate receiving portion has a depth smaller than the thickness of the flat portion of the glass substrate by up to 20%.

5. The method of claim 2, wherein a distance between a side surface of the substrate receiving portion and a side surface of the glass substrate is in a range of 1 to 2 mm.

6. The method of claim 2, wherein the substrate receiving portion is formed by cutting the second film with a laser beam.

7. The method of claim 2, wherein the first and second coating layers are formed by performing a bar coating process or a roll coating process.

8. The method of claim 7, wherein the second coating layer is formed after the first coating layer is completely cured.

9. The method of claim 7, wherein in the forming of the first coating layer and the forming of the second coating layer, the first coating layer is formed by applying a first coating solution onto an outer area of the glass substrate and then performing the bar coating process or the roll coating process, and
the second coating layer is formed on the first coating layer by applying a second coating solution onto the outer area of the glass substrate and then performing the bar coating process or the roll coating process.

10. The method of claim 9, wherein the bar coating process and the roll coating process allow each of the first and second coating layers to be sequentially formed by:
applying the coating solution and moving a bar toward the glass substrate;
applying the coating solution, forming the coating layer by moving the bar toward the glass substrate, covering top of the coating layer with a release glass, rolling a roll, and then removing the release glass; or
applying the coating solution, supplying the release glass to cover the upper portion of the glass substrate with the release glass so that the coating solution is evenly applied on the glass substrate, rolling the roll on top of the release glass, and then removing the release glass.

11. The method of claim 9, wherein during the bar coating process or the roll coating process, the first coating solution is provided between a side surface of the substrate receiving portion and a side surface of the glass substrate so that the first coating layer is further formed on the side surface of the glass substrate.

12. The method of claim 9, wherein after the second coating layer is formed, a first protective film is laminated on an upper portion of the second coating layer.

13. The method of claim 12, wherein in the separating of the glass substrate from the carrier substrate, the glass substrate is separated from the first adhesive layer after vertically cutting the first protective film, the second coating layer, and the first coating layer.

14. The method of claim 12, after the first protective film is laminated, the first film is removed, and the bar coating process or the roll coating process is performed to form a third coating layer or the third coating layer and a fourth coating layer on the back surface of the glass substrate, thereby forming the coating layer on both surfaces of the glass substrate.

15. The method of claim 14, wherein a second protective film is laminated on an upper portion of the third coating layer or an upper portion of the third and fourth coating layers.

16. The method of claim 15, wherein in the separating of the glass substrate from the carrier substrate, the second protective film, the third coating layer, the second coating layer, the first coating layer, and the first protective film are vertically cut, or
the second protective film, the fourth coating layer, the third coating layer, the second coating layer, the first coating layer, and the first protective film are vertically cut.

17. The method of claim 14, wherein the folding portion is formed on the both surfaces of the glass substrate.

18. The method of claim 1, wherein after placing the glass substrate onto the carrier substrate, a coating surface of the glass substrate is subjected to plasma treatment and then cleaned.

19. A flexible cover window containing a flat portion disposed on a flat area of a flexible display and a folding portion formed in connection to the flat portion and disposed on a folding area of the flexible display, the cover window comprising:
a glass substrate in which the folding portion is formed to have a smaller thickness than the flat portion;
a first coating layer formed on the glass substrate containing the folding portion;
a second coating layer formed on the first coating layer,
wherein the second coating layer is formed after the first coating layer is completely cured.

20. The cover window of claim 19, wherein the first coating layer is further formed on a side surface of the glass substrate.

21. The cover window of claim 19, wherein in the flexible cover window, a third coating layer or the third coating layer and a fourth coating layer are formed on a second surface of the glass substrate, thereby forming the coating layer on both surfaces of the glass substrate.

22. The cover window of claim 21, wherein the first, second, third, and fourth coating layers formed on the flat portion have a thickness in a range of 8 to 12 μm.

23. The cover window of claim 22, wherein the coating layers are formed by a bar coating process or a roll coating process.

24. The cover window of claim 22, wherein the coating layers have a thickness uniformity of 0.2 μm or less.

25. The cover window of claim 19, wherein a coating surface of the glass substrate is subjected to plasma treatment.
